(19) United States
(12) Patent Application Publication
(10) Pub. No.: US 2004/0169713 A1
(43) Pub. Date: Sep. 2, 2004

(54) Rewritable printing method and its printer

(76) Inventors: Koji Niino, Miyazaki (JP); Yoshitaka Matsumura, Miyazaki (JP); Ritsuo Ando, Miyazaki (JP)

Correspondence Address: Sheridan Ross, Suite 1200, 1560 Broadway, Denver, CO, 80202-5141, US

(21) Appl. No.: 10/477,292

(22) PCT Filed: Feb. 12, 2002
(86) PCT No.: PCT/JP02/01123

(30) Foreign Application Priority Data
May 10, 2001 (JP) 2001-140619
May 10, 2001 (JP) 2001-140620

(51) Int. Cl. B41J 2/315

(52) U.S. Cl. 347/171

(57) ABSTRACT

It is provided a rewritable printing method and its printer in which a heat sensitive medium with a leuco type coating applied is used to rewrite the information repeatedly, printing can be performed in the same way as the conventional technique, and the medium easily as the transmission means of the information, thereby extremely contributing to the improvement of environmental issues relating to the use of paper.

In a printing machine 1, a heat sensitive medium 10 set in a paper setting unit 21 is moved toward a printing processing unit 3 by a feeding roller 33, thereby printing character information by a printing head 31. While, the printed heat sensitive medium 10 set in a paper receiving unit 23 is moved toward an erasing processing unit 4 by a feeding roller 43, thereby erasing a printed portion of the heat sensitive medium 10 by an erasing head 41.

### TECHNICAL FIELD

The present invention relates to a method of printing on a rewritable medium that is chiefly a form of a paper medium and its printer.

### BACKGROUND ART

Hitherto, the information from a newspaper publisher and a publishing company is handed to a consumer in the form of printed matter with the character information printed on printing paper generally by a printer.

This, however, becomes such a serious social issue that most of the printed matter after use is actually abandoned as garbage, thereby not only increasing the cost relating to the disposal, but also consuming enormous volume of a paper resource. Although recycling of the used printing paper is partially performed as the countermeasures for the disposal of the paper, there is such a problem that not only a lot of labor is required for calling in the used printing paper but also enormous energy is required for reproducing processing of the collected paper.

On the other hand, recently, with the prevalence of a computer, there is a remarkable trend of decreasing the use of paper by computerizing communication and public procedure based on the term of “development of IT”. However, it is not so much developed as to fully cover the advantage of the communication of the paper medium. All of the people cannot use a computer freely and only a restricted person can carry a computer freely under a restricted situation in the present circumstances. Accordingly, a method of transmitting various information through the paper medium will be inevitably continued to be used for a while.

Accordingly, the most preferable method is a method of using the paper medium as the information medium while resolving the above-mentioned issues of the paper resource and the energy. The above method includes a repeated use of a medium having a rewritable function.

This is the technology represented by a reward card of these days and the means of rewriting includes heat, electric charge, light, and so on. As a general use, for example, a mixed one of the leuco dye and reversible developer are applied on the surface of the medium and by use of this heat characteristic, printing and erasing is repeatedly performed.

For example, there is “Method for Printing Leuco Type Rewrite Card Using Rewrite Card Reader” disclosed in JP-A-10-324011. This method is to do both printing and erasing by heating, and to solve such a disadvantage that desired printing cannot be performed due to the remaining heat after erasing when performing the printing continuously after the erasing. Specifically, it can shorten the coolant time from 15 seconds in the conventional technique to about 2 seconds by performing the forcible cooling. The leuco dye is used for a card as well as it is applied on the paper to make “rewritable heat sensitive paper”, and its use recently comes into the spotlight.

The invention also aims to provide a rewritable printing method and its printer in which a heat sensitive medium with the leuco dye applied is used to rewrite the information repeatedly, printing can be performed in the same way as the conventional technique, and the medium can be used easily as the transmission means of the information, thereby extremely contributing to the improvement of environmental issues relating to the use of paper.

### DISCLOSURE OF THE INVENTION

Accordingly, the invention comprises a printing processing unit for printing on a rewritable heat sensitive medium and an erasing processing unit for erasing the printed portion of the printed heat sensitive medium. Therefore, the heat sensitive medium can be repeatedly used, thereby contributing to the protection of the environment.

Further, a heating temperature toward the heat sensitive medium at an erasing mode is more than the temperature of the lower limit of a discoloring area and less than the temperature of the lower limit of a coloring area when printing continuously after erasing the printed heat sensitive medium with the leuco type coating applied. Therefore, assured erasing processing can be performed by minimizing ill effects on the printing in printing and erasing in series by one machine.

### BRIEF DESCRIPTION OF THE DRAWINGS

FIG. 1 is a lateral side cross sectional view schematically showing the structure of a printer of a first embodiment;

FIG. 2 is a lateral side cross sectional view schematically showing the structure of a printer of a second embodiment;

FIG. 3 is an image view for use in describing the coloring/discoloring mechanism of the leuco dye; and

FIG. 4 is a graph showing the relationship between the resolution and the printing energy.

### BEST MODE FOR CARRYING OUT THE INVENTION

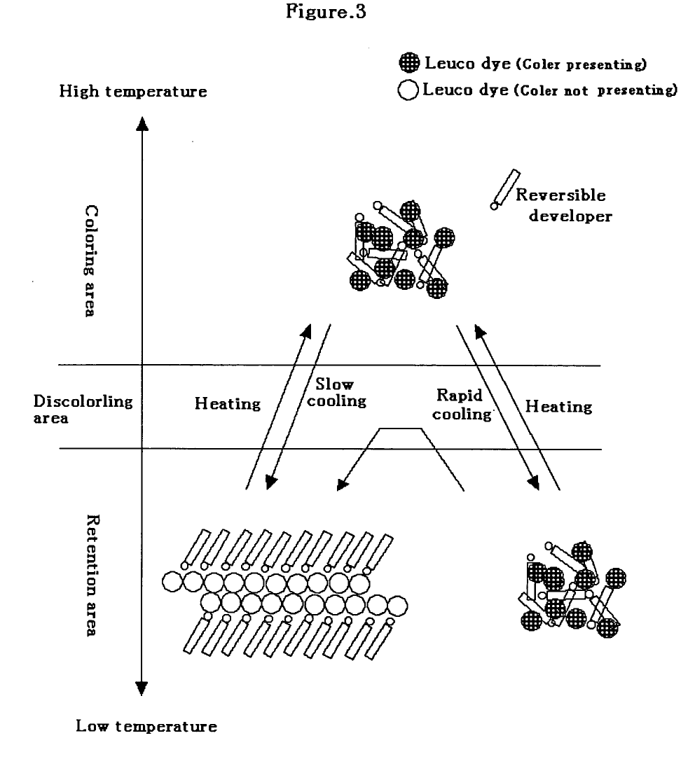

For the convenience's sake, the outline of the leuco type rewrite paper used for this invention will be described with reference to FIG. 3.

The principle of the leuco type rewrite paper is based on the crystal characteristic that the leuco dye and the reversible developer included in the leuco type coating agent present the color only in a mixed state. Namely, as shown in FIG. 3, the leuco dye and the reversible developer do not present the color in a state of crystallization in each layer. Being heated to exceed each boiling point and reach each coloring area, the leuco dye and the reversible developer are mixed, hence to present the color. When this is rapidly cooled to a retention area by some rate and more, it is solidified as in mixed state, thereby retaining the coloring state.

On the other hand, when the slow cooling by some rate and less, the priority is given to the crystal of the reversible developer, which results in separating the layers of two components and losing the color. Namely, in order to erase the matter once printed, it is necessary to melt the leuco dye and the reversible developer coloring in the retention area and gradually cool them. As the heating temperature for melting, when it is heated up to the coloring area and gradually cooled, assured erasing can be achieved. It is not heated up to the coloring area but remains in the discoloring area and it may be cooled up to the retention area. This erasing method can lessen the remaining heat and it can be adopted to the continuous printing after erasing as described later.

The phase of the coloring can be black, red, blue, green, and yellow, as for the leuco type rewrite paper used in the invention. The discoloring area temperature ranges generally from 120° C. to 180° C. and a heater or a thermal head is used as the erasing head.

On the other hand, in the printing under the circumstances of the room temperature, heating is performed in every dot of small area, hence to avoid the heat from remaining and naturally cool the printing rapidly. It is preferable that the heating amount exceeds slightly the lower limit of the above coloring area temperature. Accordingly, in the case of 8 dots/mm (=203 dpi) as a reference, the heat of 0.1 mJ to 5 mJ per one dot is applied and especially the heat of 0.3 to 0.7 mJ is most practical. As the printing head, the thermal head or the thermal laser may be used.

Further, not only one side but also the double sides of the heat sensitive medium may be used, thereby increasing the number of the rewritable times of the heat sensitive medium twice and extending the lifespan. Further, in the double side-type, a plurality of erasing heads and printing heads can be provided in each of the erasing processing unit and the printing processing unit and the erasing processing and the printing processing can be simultaneously performed on the both sides of the heat sensitive medium.

When performing the erasing and the printing in series, in the case of forcible cooling like that of the conventional technique, if the other factor such as outside air is not adjusted well, there remains a fear that the whole medium may represent the color when the cooling speed is too fast. In this point, if the heating is performed within the discoloring area, erasing can be performed assuredly by depending on the natural cooling.

On the other hand, in the printing continuously after the erasing, when the cooling after erasing depends on the natural cooling, there remains a fear that the excessive heating in the printing due to the remaining heat and the outside air may disturb the assured printing. In order to solve this, the heating condition in the printing is adjusted by a factor obtained by the temperature of the outside air and the medium while the cooling after the erasing depends on the natural cooling, thereby enabling the assured printing. More specifically, an outside air temperature sensor and a medium temperature sensor are provided and based on the temperature information obtained by them, the amount of energy to the printing head of the printing processing unit is adjusted, not to cause the excessive heating.

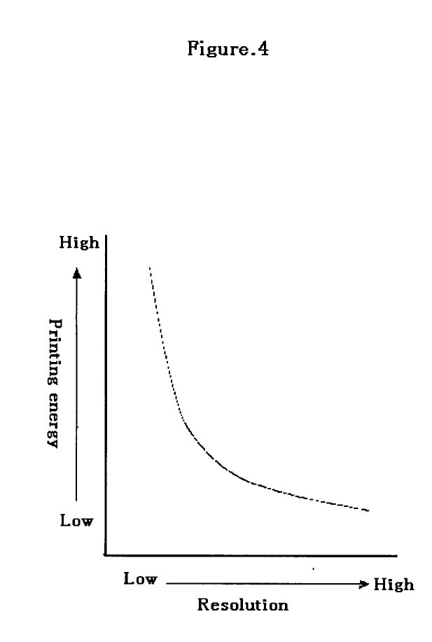

As mentioned above, the heating energy has been described with the printing head of 203 dpi as a reference (for example, one dot=width 0.11 mm×height 0.13 mm, space between dots=0.015 mm as the standard). In the future, the use of the higher resolution of the printing such as 300 dpi and 600 dpi is anticipated. The printing energy to be loaded for printing is designed to decrease according to the improvement of the resolution, as shown in the graph of FIG. 4.

Hereinafter, each embodiment of the invention will be described according to the drawings.

Embodiment 1

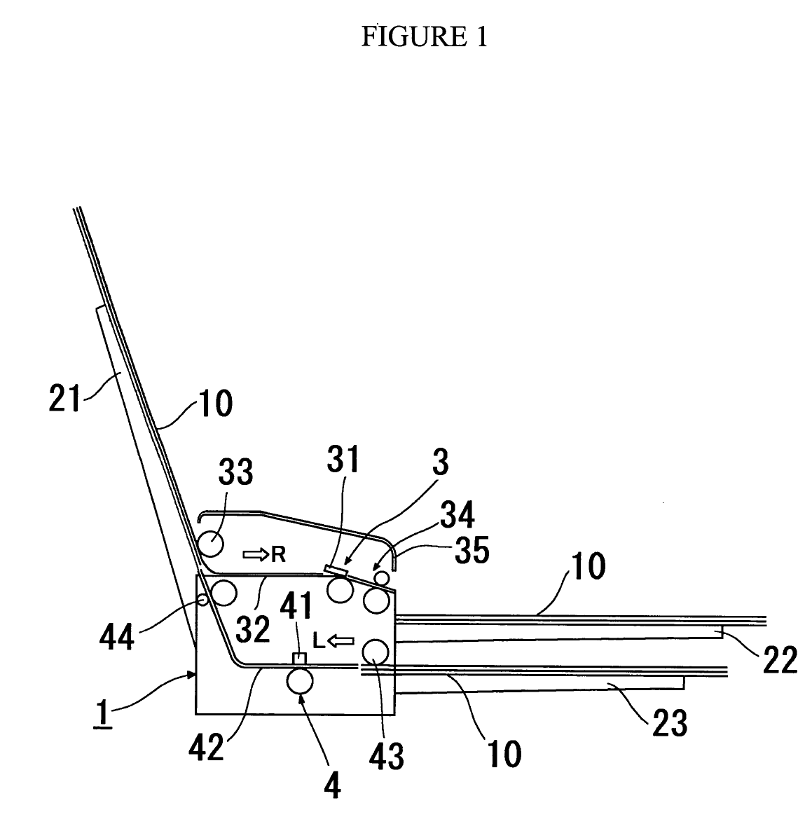

As shown in FIG. 1, a printing machine 1 of this embodiment is designed to print and erase the visual information of such as a computer or a fax on a rewritable heat sensitive medium 10 made from leuco type rewritable material, by itself. A paper setting unit (stocker) 21 is mounted on the left end upper portion of the printing machine 1, designed to set the heat sensitive medium 10 before the printing processing (not used or erasing-processed). The printing processing unit 3 and the erasing processing unit 4 are vertically provided in the printing machine 1, and paper carriages 32 and 42 for carrying the heat sensitive medium 10 in the right direction or the left direction are respectively formed in the both processing units 3 and 4.

A feeding roller 33, a printing head 31, a forwarding roller 34, and an upper paper receiving unit 23 are sequentially provided along the upper paper carriage 32 in the forwarding direction (right direction R) and they are protected by a cover 35. The heat sensitive medium 10 set in the paper setting unit 21 is moved to the printing processing unit 3 by the feeding roller 33 and after the movement, the character information is printed by the printing head 31. As the printing head 31, a thermal head or a thermal laser is used. The heat sensitive medium 10 after printing is carried to the paper receiving unit 22 by the forwarding roller 34.

On the other hand, a lower paper receiving unit 23, a feeding roller 43, an erasing head 41, and a forwarding roller 44 are sequentially provided along the lower paper carriage 42 in the forwarding direction (left direction L). The printed heat sensitive medium 10 set in the paper receiving unit 23 is moved to the erasing processing unit 4 by the feeding roller 43, and after the movement, the printed portion of the heat sensitive medium 10 is erased by the erasing head 41. The heat sensitive medium 10 after erasing is forwarded to the paper setting unit 3 by the forwarding roller 44.

Embodiment 2

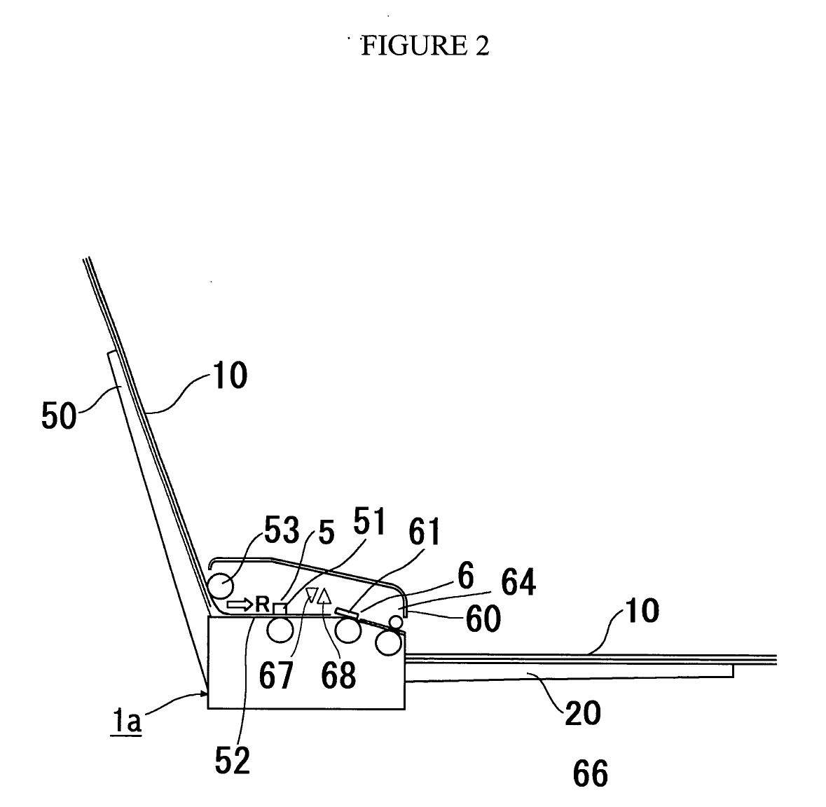

As illustrated in FIG. 2, also the printing machine 1a can do the erasing and the printing in series, it is provided with the erasing processing unit 5 and the printing processing unit 6, and a paper setting unit 50 is installed in the upper left portion of the printing machine 1a. One paper carriage 52 is formed on the upper portion of the printing machine 1a, designed to carry the heat sensitive medium 10 in the right direction by the feeding roller 53.

The feeding roller 53, the erasing head 51, the printing head 61, the forwarding roller 64 and the paper receiving unit 66 are sequentially provided in the forwarding direction (right direction R) along the paper carriage 52. The heat sensitive medium 10 before the erasing processing is sequentially moved to the erasing processing unit 5 and the printing processing unit 6 by the feeding roller 53 and the printed portion of the heat sensitive medium 10 is erased by the erasing head 51. The temperature condition at the erasing time is fixed in the range of 120° C. to 180° C.

The air temperature sensor 67 and the medium temperature sensor 68 are provided in the printing processing unit 6, thereby obtaining the air temperature information in use circumstance and the temperature information on the surface of the heat sensitive medium 10 sent from the erasing processing unit 5. The printing machine 1a processes the above temperature information, calculates the heating energy proper for printing, and adjusts the printing energy on the printing head 61.

The heat sensitive medium 10 after erasing is newly printed by the printing head 61, and the heat sensitive medium 10 after printing is forwarded to the paper receiving unit 66 by the forwarding roller 64. The printing energy applied at the printing time is fixed in the range of 0.3 mJ to 0.7 mJ per one dot (8 dots/mm).

Constituted as mentioned above, the invention has the following excellent effects.

(1) By using a rewritable heat sensitive medium and providing the printing processing unit and the erasing processing unit, the heat sensitive medium can be reused repeatedly and therefore waste of the paper resources can be prevented and the amount of energy consumption can be extremely decreased.

(2) Since the proper heating processing is performed in recycling the heat sensitive medium once printed, assured printing processing can be achieved without damaging the following printing processing.

(3) In the case of performing the printing processing again continuously after the erasing processing of the heat sensitive medium once printed, even when there remains the heat in the erasing processing due to the influence of the using environment, the proper printing can be achieved without receiving the same influence.

### INDUSTRIAL APPLICABILITY

As mentioned above, the invention concerned with this invention can be used not only as a printer of good versatility but also as a printer for an information device with a communication function such as a personal computer, a facsimile, or the like.

1. A rewritable printer characterized by comprising a printing processing unit for printing on a rewritable heat sensitive medium and an erasing processing unit for erasing a printed portion of the printed heat sensitive medium.

2. The rewritable printer, according to claim 1, characterized by comprising a stocker for storing the heat sensitive medium with the printed portion erased by the erasing processing unit and feeding means for feeding the heat sensitive medium to the printing processing unit.

3. The rewritable printer, according to claim 1 or 2, characterized by sequentially providing the erasing processing unit and the printing processing unit in a paper carriage of a printing machine.

4. The rewritable printer, according to claim 1 or 2, characterized by separately forming the erasing processing unit and the printing processing unit.

5. A rewritable printing method characterized in that a heating temperature toward the heat sensitive medium at an erasing mode is more than a temperature of lower limit of a discoloring area and less than a temperature of lower limit of a coloring area when printing continuously after erasing printing of the heat sensitive medium with leuco type coating applied.

6. The rewritable printing method, according to claim 5, characterized in that the heating temperature toward the heat sensitive medium at the erasing mode ranges from 120° C. to 180° C.

7. The rewritable printing method, according to claim 5, characterized in that an energy to be loaded in order to heat for the printing in printing continuously after erasing is changed according to an outside air temperature and/or a surface temperature of the heat sensitive medium.

8. The rewritable printing method, according to claim 5 or 7, characterized in that printing is performed by a printing head with printing resolution from 200 dpi to 600 dpi and the energy to be loaded in order to heat for the printing ranges from 0.1 mJ to 5 mJ per one dot.
